(19) United States
(12) Patent Application Publication
(10) Pub. No.: US 2025/0282355 A1
(43) Pub. Date: Sep. 11, 2025

(54) SURROUNDING SITUATION RECOGNITION DEVICE, SURROUNDING SITUATION RECOGNITION METHOD, AND NON-TRANSITORY RECORDING MEDIUM

(71) Applicant: TOYOTA JIDOSHA KABUSHIKI KAISHA, Toyota-shi Aichi-ken (JP)

(72) Inventor: Masamichi Ohsugi, Sunto-gun Shizuoka-ken (JP)

(73) Assignee: TOYOTA JIDOSHA KABUSHIKI KAISHA, Toyota-shi Aichi-ken (JP)

(21) Appl. No.: 19/063,806

(22) Filed: Feb. 26, 2025

(30) Foreign Application Priority Data
Mar. 6, 2024 (JP) 2024-033824

(51) Int. Cl. B60W 30/18; G08G 1/16

(52) U.S. Cl. CPC B60W 30/18009; G08G 1/166; B60W 2552/00; B60W 2554/4043; B60W 2554/4045; B60W 2754/20

(57) ABSTRACT

A surrounding situation recognition device determines whether a surrounding vehicle located in the vicinity of a host vehicle is loading the object, calculates a parameter representing behavior of the surrounding vehicle, and determine whether it is necessary to make the distance between the surrounding vehicle and the host vehicle greater than or equal to a predetermined value based on the parameter representing the behavior of the surrounding vehicle when it is determined that the surrounding vehicle is loading the object.

### CROSS-REFERENCE TO RELATED APPLICATIONS

This application claims priority to Japanese Patent Application No. 2024-033824 filed Mar. 6, 2024, the entire contents of which are herein incorporated by reference.

### FIELD

The present disclosure relates to surrounding situation recognition device, surrounding situation recognition method, and non-transitory recording medium.

### BACKGROUND

PTL 1 (JP-A-2020-170370) discloses a technique in which it is determined whether there is a possibility that an object falls from a load-carrying tray of a surrounding vehicle traveling in the vicinity of a vehicle (host vehicle) or the object is falling according to calculation result of at least any one or more of vibration frequency, amplitude and size of the object. In the technique described in PTL 1, in order to be able to calculate any one or more of the vibration frequency, the amplitude and the size of the object, it is necessary to make the host vehicle move closer to the surrounding vehicle. That is, in the technique described in PTL 1, because it is necessary to make the host vehicle move closer to the surrounding vehicle from which the object may fall, there is a possibility that an occupant of the host vehicle is put in danger.

It is considered that the technique in which the distance between the surrounding vehicle (surrounding vehicle) from which the object may fall and the host vehicle is kept is necessary rather than the technique in which the host vehicle is caused to move closer to the surrounding vehicle from which the object may fall as the technique described in PTL 1, in order to improve the safety of the occupant of the host vehicle.

In the technique described in PTL 1, driving assistance is performed in a different manner according to result of determination whether there is the possibility that the object falls from the load-carrying tray of the surrounding vehicle or the object is falling. In the technique described in PTL 1 as described above, because it is necessary to make the host vehicle move closer to the surrounding vehicle, there is a possibility that the appropriate driving assistance which is beneficial to the occupant of the host vehicle cannot be performed.

### SUMMARY

In view of the above-described points, it is an object of the present disclosure to provide surrounding situation recognition device, surrounding situation recognition method, and non-transitory recording medium that can appropriately improve the safety of the host vehicle when the surrounding vehicle from which a load may fall exists.

(1) One aspect of the present disclosure is a surrounding situation recognition device including a processor configured to: determine whether a surrounding vehicle located in the vicinity of a host vehicle is loading the object; calculate a parameter representing behavior of the surrounding vehicle; and determine whether it is necessary to make the distance between the surrounding vehicle and the host vehicle greater than or equal to a predetermined value based on the parameter representing the behavior of the surrounding vehicle when it is determined that the surrounding vehicle is loading the object.

(2) In the surrounding situation recognition device of the aspect (1), acceleration and deceleration of the surrounding vehicle and acceleration of the surrounding vehicle in the horizontal direction in an image which shows measurement result of a surrounding situation sensor mounted on the host vehicle may be included in the parameter representing the behavior of the surrounding vehicle, and the processor may be configured to: determine that it is necessary to make the distance between the surrounding vehicle and the host vehicle greater than or equal to the predetermined value when it is determined that the surrounding vehicle is loading the object and when the acceleration or the deceleration of the surrounding vehicle is greater than or equal to a first threshold value; and determine that it is necessary to make the distance between the surrounding vehicle and the host vehicle greater than or equal to the predetermined value when it is determined that the surrounding vehicle is loading the object and when the acceleration of the surrounding vehicle in the horizontal direction is greater than or equal to a second threshold value.

(3) In the surrounding situation recognition device of the aspect (1) or (2), the processor may be configured to: estimate road surface situation of a road on which the surrounding vehicle and the host vehicle are traveling; and determine that it is necessary to make the distance between the surrounding vehicle and the host vehicle greater than or equal to the predetermined value based on the parameter representing the behavior of the surrounding vehicle and the road surface situation when it is determined that the surrounding vehicle is loading the object.

(4) Another aspect of the present disclosure is a surrounding situation recognition method including: determining whether a surrounding vehicle located in the vicinity of a host vehicle is loading the object; calculating a parameter representing behavior of the surrounding vehicle; and determining whether it is necessary to make the distance between the surrounding vehicle and the host vehicle greater than or equal to a predetermined value based on the parameter representing the behavior of the surrounding vehicle when it is determined that the surrounding vehicle is loading the object.

(5) Another aspect of the present disclosure is a non-transitory recording medium having recorded thereon a computer program for causing a processor to perform a process including: determining whether a surrounding vehicle located in the vicinity of a host vehicle is loading the object; calculating a parameter representing behavior of the surrounding vehicle; and determining whether it is necessary to make the distance between the surrounding vehicle and the host vehicle greater than or equal to a predetermined value based on the parameter representing the behavior of the surrounding vehicle when it is determined that the surrounding vehicle is loading the object.

According to the present disclosure, it is possible to appropriately improve the safety of the host vehicle when the surrounding vehicle from which a load may fall exists.

### BRIEF DESCRIPTION OF DRAWINGS

FIG. 1 is a view showing an example of a host vehicle 1 to which a surrounding situation recognition device 15 of a first embodiment is applied.

FIG. 2 is a flowchart for explaining an example of a process performed by a processor 153 of the surrounding situation recognition device 15 of the first embodiment.

FIG. 3 is a view showing an example of the host vehicle 1 to which the surrounding situation recognition device 15 of a fifth embodiment is applied.

FIG. 4 is a flowchart for explaining an example of the process performed by the processor 153 of the surrounding situation recognition device 15 of the fifth embodiment.

### DESCRIPTION OF EMBODIMENTS

Below, referring to the drawings, embodiments of surrounding situation recognition device, surrounding situation recognition method, and non-transitory recording medium of the present disclosure will be explained.

### First Embodiment

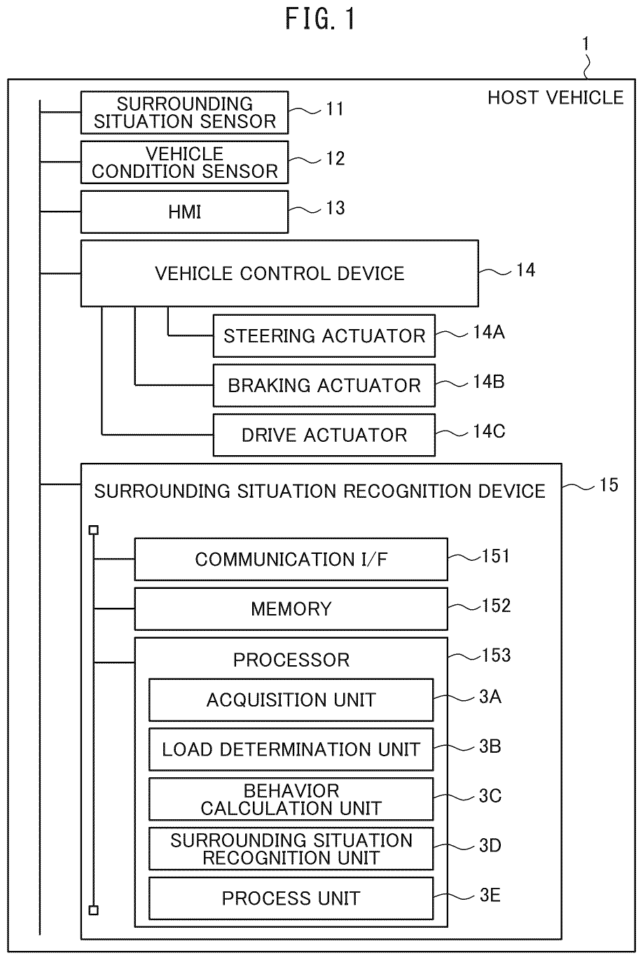

FIG. 1 is a view showing an example of a host vehicle 1 to which a surrounding situation recognition device 15 of a first embodiment is applied.

In the example shown in FIG. 1, the host vehicle 1 includes surrounding situation sensor 11, vehicle condition sensor 12, HMI (Human Machine Interface) 13, vehicle control device 14, steering actuator 14A, braking actuator 14B, drive actuator 14C, and surrounding situation recognition device 15.

The surrounding situation sensor 11 measures a surrounding situation of the host vehicle 1 (for example, surrounding vehicle located in the vicinity of the host vehicle 1, object mounted on the surrounding vehicle, obstacle located in the vicinity of the host vehicle 1, and the like), and transmits the measurement result of the surrounding situation of the host vehicle 1 to the vehicle control device 14 and the surrounding situation recognition device 15. The surrounding situation sensor 11 includes, for example, camera, LiDAR (Light Detection And Ranging) or the like.

The vehicle condition sensor 12 measures the condition of the host vehicle 1, and transmits the measurement result of the condition of the host vehicle 1 to the vehicle control device 14 and the surrounding situation recognition device 15. The vehicle condition sensor 12 includes, for example, vehicle speed sensor, acceleration sensor, yaw rate sensor, gyro sensor, and the like.

The HMI 13 has the function of receiving various operations of a driver of the host vehicle 1 and the like, and transmits signals indicating the operations of the driver of the host vehicle 1 to the vehicle control device 14.

The vehicle control device 14 controls the steering actuator 14A, the braking actuator 14B, and the drive actuator 14C based on information (data, signals) transmitted from, for example, the surrounding situation sensor 11, the vehicle condition sensor 12, and the HMI 13.

The surrounding situation recognition device 15 is configured by a microcomputer including communication interface (I/F) 151, memory 152, and processor 153.

The communication interface 151 includes an interface circuit for connecting the surrounding situation recognition device 15 to the surrounding situation sensor 11, the vehicle condition sensor 12, the HMI 13, and the vehicle control device 14. The memory 152 stores a program used in a process performed by the processor 153 and various data.

The processor 153 has the function as an acquisition unit 3A, the function as a load determination unit 3B, the function as a behavior calculation unit 3C, the function as a surrounding situation recognition unit 3D, and the function as a process unit 3E.

The acquisition unit 3A acquires the measurement result of the surrounding situation sensor 11 from the surrounding situation sensor 11. The measurement result of the surrounding situation sensor 11 includes, for example, an image including the surrounding vehicle and an object mounted on the surrounding vehicle shot by a camera as the surrounding situation sensor 11, the measurement result (e.g., three-dimensional image, etc.) of the surrounding vehicle and the object mounted on the surrounding vehicle by the LiDAR as the surrounding situation sensor 11 and the like. The acquisition unit 3A acquires the measurement result of the vehicle condition sensor 12 from the vehicle condition sensor 12.

The load determination unit 3B determines whether the surrounding vehicle is loading the object based on the measurement result of the surrounding situation sensor 11 acquired by the acquisition unit 3A. Specifically, the load determination unit 3B determines whether the surrounding vehicle is loading the object based on the measurement result of the surrounding situation sensor 11, for example, by using a model obtained by performing learning using teacher data which is a data set of the measurement result of a surrounding situation sensor mounted on a learning vehicle and the label indicating whether the surrounding vehicle (learning surrounding vehicle) which is located in the vicinity of the learning vehicle and which is the measurement target of the surrounding situation sensor mounted on the learning vehicle is loading the object (learning object).

The behavior calculation unit 3C calculates a parameter representing behavior of the surrounding vehicle based on the measurement result of the surrounding situation sensor 11 and the measurement result of the vehicle condition sensor 12 acquired by the acquisition unit 3A.

Specifically, the parameter representing the behavior of the surrounding vehicle includes acceleration and deceleration of the surrounding vehicle. The behavior calculation unit 3C calculates the acceleration or deceleration of the surrounding vehicle in the front-back direction (travel direction) with respect to the road surface of the road on which the surrounding vehicle and the host vehicle 1 are traveling based on the acceleration or deceleration of the host vehicle 1 indicated by the measurement result of the vehicle condition sensor 12 acquired by the acquisition unit 3A and the acceleration or deceleration of the surrounding vehicle in the front-back direction (travel direction) in the image which shows the measurement result of the surrounding situation sensor 11 acquired by the acquisition unit 3A.

In addition, the parameter representing the behavior of the surrounding vehicle includes the acceleration of the surrounding vehicle in the horizontal direction (direction intersecting the travel direction) indicating the steepness of the steering of the surrounding vehicle. The behavior calculation unit 3C calculates the acceleration of the surrounding vehicle in the horizontal direction (direction intersecting the travel direction) in the image which shows the measurement result of the surrounding situation sensor 11 acquired by the acquisition unit 3A based on the image.

The surrounding situation recognition unit 3D determines whether it is necessary to make the distance between the surrounding vehicle and the host vehicle 1 greater than or equal to a predetermined value based on the parameter representing the behavior of the surrounding vehicle calculated by the behavior calculation unit 3C when it is determined that the surrounding vehicle is loading the object by the load determination unit 3B.

Specifically, the surrounding situation recognition unit 3D determines that it is necessary to make the distance between the surrounding vehicle and the host vehicle 1 greater than or equal to the predetermined value when it is determined that the surrounding vehicle is loading the object by the load determination unit 3B and when the acceleration or the deceleration of the surrounding vehicle is greater than or equal to a first threshold value. The “predetermined value” is, for example, a distance at which it is possible to suppress the risk of collision between the object and the host vehicle 1 and the like even when the object falls from the surrounding vehicle to the vicinity of the host vehicle 1.

In addition, the surrounding situation recognition unit 3D determines that it is necessary to make the distance between the surrounding vehicle and the host vehicle greater than or equal to the predetermined value when it is determined that the surrounding vehicle is loading the object by the load determination unit 3B and when the acceleration of the surrounding vehicle in the horizontal direction is greater than or equal to a second threshold value.

That is, in the example shown in FIG. 1, the surrounding situation recognition unit 3D determines whether it is necessary to make the distance between the surrounding vehicle and the host vehicle 1 greater than or equal to the predetermined value (i.e., determines whether the object is likely to fall from the surrounding vehicle) not only based on the information indicating whether the object which may fall is loaded on the surrounding vehicle, but also based on the motion (behavior) of the surrounding vehicle which is loading the object. Therefore, it is possible to improve the safety of the host vehicle 1 more appropriately than the technique in which it is necessary to make the host vehicle 1 move closer to the surrounding vehicle from which the object may fall, for example, such as the technique described in PTL 1.

The process unit 3E performs a process for causing the HMI 13 to output a warning indicating that it is necessary to make the distance between the surrounding vehicle and the host vehicle greater than or equal to the predetermined value when the surrounding situation recognition unit 3D determines that it is necessary to make the distance between the surrounding vehicle and the host vehicle greater than or equal to the predetermined value.

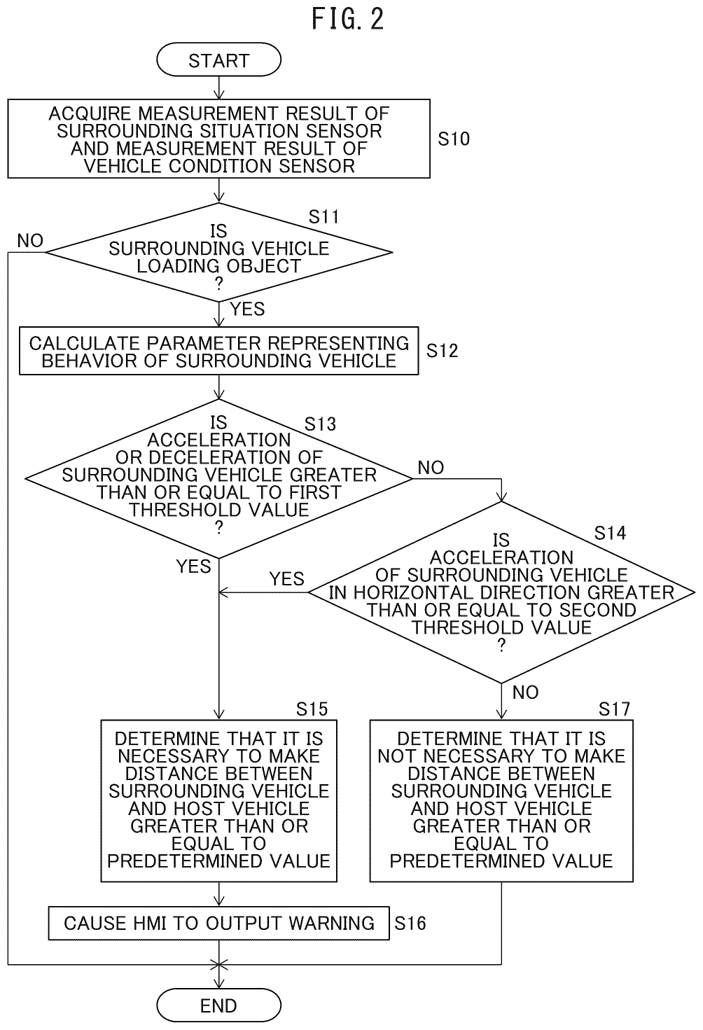

FIG. 2 is a flowchart for explaining an example of the process performed by the processor 153 of the surrounding situation recognition device 15 of the first embodiment.

In the example shown in FIG. 2, at step S10, the acquisition unit 3A acquires the measurement result of the surrounding situation sensor 11 from the surrounding situation sensor 11. The acquisition unit 3A acquires the measurement result of the vehicle condition sensor 12 from the vehicle condition sensor 12.

At step S11, the load determination unit 3B determines whether the surrounding vehicle is loading the object based on the measurement result of the surrounding situation sensor 11 acquired at step S10. When YES, it proceeds to step S12; when NO, the process shown in FIG. 2 ends.

At step S12, the behavior calculation unit 3C calculates the parameter (acceleration or deceleration of the surrounding vehicle in the front-back direction with respect to the road surface, acceleration of the surrounding vehicle in the horizontal direction in the image which shows the measurement result of the surrounding situation sensor 11) representing the behavior of the surrounding vehicle based on the measurement result of the surrounding situation sensor 11 and the measurement result of the vehicle condition sensor 12 acquired at step S10.

At step S13, the surrounding situation recognition unit 3D determines whether the acceleration or the deceleration of the surrounding vehicle in the front-back direction with respect to the road surface calculated at step S12 is greater than or equal to the first threshold value. When YES, it proceeds to step S15; when NO, it proceeds to step S14.

At step S14, the surrounding situation recognition unit 3D determines whether the acceleration of the surrounding vehicle in the horizontal direction in the image which shows the measurement result of the surrounding situation sensor 11 calculated at step S12 is greater than or equal to the second threshold value. When YES, it proceeds to step S15; when NO, it proceeds to step S17.

At step S15, the surrounding situation recognition unit 3D determines that it is necessary to make the distance between the surrounding vehicle and the host vehicle 1 greater than or equal to the predetermined value. In other words, the surrounding situation recognition unit 3D determines that the object which is loaded on the surrounding vehicle may fall from the surrounding vehicle.

At step S16, the process unit 3E performs the process for causing the HMI 13 to output the warning indicating that it is necessary to make the distance between the surrounding vehicle and the host vehicle greater than or equal to the predetermined value.

At step S17, the surrounding situation recognition unit 3D determines that it is not necessary to make the distance between the surrounding vehicle and the host vehicle 1 greater than or equal to the predetermined value. In other words, the surrounding situation recognition unit 3D determines that there is no possibility that the object which is loaded on the surrounding vehicle falls from the surrounding vehicle.

### Second Embodiment

The host vehicle 1 to which the surrounding situation recognition device 15 of a second embodiment is applied is configured similarly to the host vehicle 1 to which the surrounding situation recognition device 15 of the first embodiment described above is applied, except that it will be described later.

In the example shown in FIG. 1 (example of the host vehicle 1 to which the surrounding situation recognition device 15 of the first embodiment is applied), the vehicle control device 14 does not have an autonomous driving function in which the host vehicle 1 is autonomously driven by controlling the steering actuator 14A, the braking actuator 14B, and the drive actuator 14C without the need for operation by the driver of the host vehicle 1.

On the other hand, in an example of the host vehicle 1 to which the surrounding situation recognition device 15 of the second embodiment is applied, the vehicle control device 14 has the autonomous driving function in which the vehicle 1 is autonomously driven by controlling the steering actuator 14A, the braking actuator 14B, and the drive actuator 14C without the need for operation by the driver of the host vehicle 1. Specifically, the vehicle control device 14 generates a travel plan for the host vehicle 1 to reach a destination based on, for example, map information, position information of the host vehicle 1, information indicating the destination of the host vehicle 1, and the like. Furthermore, the vehicle control device 14 causes the host vehicle 1 to travel autonomously according to the travel plan. Specifically, the vehicle control device 14 causes the host vehicle 1 to travel autonomously while correcting the travel plan so as to avoid a collision or the like between the host vehicle 1 and the surrounding vehicle based on the measurement result or the like of the surrounding situation sensor 11.

In the example shown in FIG. 1 (example of the host vehicle 1 to which the surrounding situation recognition device 15 of the first embodiment is applied), as described above, when the surrounding situation recognition unit 3D determines that it is necessary to make the distance between the surrounding vehicle and the host vehicle 1 greater than or equal to the predetermined value (when the surrounding situation recognition unit 3D determines that the object which is loaded on the surrounding vehicle may fall from the surrounding vehicle), the process unit 3E performs the process for causing the HMI 13 to output the warning indicating that it is necessary to make the distance between the surrounding vehicle and the host vehicle greater than or equal to the predetermined value.

On the other hand, in the example of the host vehicle 1 to which the surrounding situation recognition device 15 of the second embodiment is applied, when the surrounding situation recognition unit 3D determines that it is necessary to make the distance between the surrounding vehicle and the host vehicle 1 greater than or equal to the predetermined value (when the surrounding situation recognition unit 3D determines that the object which is loaded on the surrounding vehicle may fall from the surrounding vehicle), the process unit 3E causes the vehicle control device 14 to perform correction of the travel plan for allowing the host vehicle 1 to safely travel without the collision between the object and the host vehicle 1 or the like even if the object falls from the surrounding vehicle to the vicinity of the host vehicle 1. The vehicle control device 14 performs correction of the travel plan in accordance with an instruction from the process unit 3E, and causes the host vehicle 1 to travel autonomously according to the corrected travel plan.

Therefore, in the example of the host vehicle 1 to which the surrounding situation recognition device 15 of the second embodiment is applied, even when the object falls from the surrounding vehicle to the vicinity of the host vehicle 1, it is possible to suppress the risk of collision between the object and the host vehicle 1 and the like. In detail, it is possible to appropriately improve the safety of the host vehicle 1 based on the motion (behavior) of the surrounding vehicle which is loading the object, without the need to calculate the vibration frequency, amplitude, size, or the like of the object as in the technique described in PTL 1.

### Third Embodiment

The host vehicle 1 to which the surrounding situation recognition device 15 of a third embodiment is applied is configured similarly to the host vehicle 1 to which the surrounding situation recognition device 15 of the first embodiment described above is applied, except that it will be described later.

In the example shown in FIG. 1 (example of the host vehicle 1 to which the surrounding situation recognition device 15 of the first embodiment is applied), although the load determination unit 3B has the function of determining whether the surrounding vehicle is loading the object, the load determination unit 3B does not have the function of determining whether the object which is loaded on the surrounding vehicle is in an overloaded state. The load determination unit 3B does not have the function of determining whether the object which is loaded on the surrounding vehicle is in a state where the object is protruding from the surrounding vehicle. The load determination unit 3B does not have the function of determining whether the object which is loaded on the surrounding vehicle is in a state where the object is not fixed to the surrounding vehicle.

On the other hand, in an example of the host vehicle 1 to which the surrounding situation recognition device 15 of the third embodiment is applied, the load determination unit 3B has the function of determining whether the surrounding vehicle is loading the object, the function of determining whether the object which is loaded on the surrounding vehicle is in the overloaded state, the function of determining whether the object which is loaded on the surrounding vehicle is in the state where the object is protruding from the surrounding vehicle, and the function of determining whether the object which is loaded on the surrounding vehicle is in the state where the object is not fixed to the surrounding vehicle. The load determination unit 3B determines whether the object which is loaded on the surrounding vehicle is in the overloaded state based on the measurement result of the surrounding situation sensor 11 by using a model obtained by performing learning using teacher data which is a data set of the measurement result of the surrounding situation sensor mounted on the learning vehicle and the label indicating whether the object (learning object) loaded on the surrounding vehicle (learning surrounding vehicle) which is located in the vicinity of the learning vehicle and which is the measurement target of the surrounding situation sensor mounted on the learning vehicle is in the overloaded state. In addition, the load determination unit 3B determines whether the object which is loaded on the surrounding vehicle is in the state where the object is protruding from the surrounding vehicle based on the measurement result of the surrounding situation sensor 11 by using a model obtained by performing learning using teacher data which is a data set of the measurement result of the surrounding situation sensor mounted on the learning vehicle and the label indicating whether the object (learning object) loaded on the surrounding vehicle (learning surrounding vehicle) which is located in the vicinity of the learning vehicle and which is the measurement target of the surrounding situation sensor mounted on the learning vehicle is in the state where the object is protruding from the learning surrounding vehicle. Further, the load determination unit 3B determines whether the object which is loaded on the surrounding vehicle is in the state where the object is not fixed to the surrounding vehicle based on the measurement result of the surrounding situation sensor 11 by using a model obtained by performing learning using teacher data which is a data set of the measurement result of the surrounding situation sensor mounted on the learning vehicle and the label indicating whether the object (learning object) loaded on the surrounding vehicle (learning surrounding vehicle) which is located in the vicinity of the learning vehicle and which is the measurement target of the surrounding situation sensor mounted on the learning vehicle is in the state where the object is not fixed to the learning surrounding vehicle.

In other words, in the example of the vehicle 1 to which the surrounding situation recognition device 15 of the third embodiment is applied, a case when it is determined that the surrounding vehicle is loading the object by the load determination unit 3B includes case (first case) when (the load determination unit 3B determines that) the object which is loaded on the surrounding vehicle is in the overloaded state, case (second case) when (the load determination unit 3B determines that) the object which is loaded on the surrounding vehicle is in the state where the object is protruding from the surrounding vehicle, case (third case) when (the load determination unit 3B determines that) the object which is loaded on the surrounding vehicle is in the state where the object is not fixed to the surrounding vehicle, and case (fourth case) which does not correspond to none of the first to third cases. In the fourth case, the load determination unit 3B determines that the surrounding vehicle is loading the object, the load determination unit 3B determines that the object which is loaded on the surrounding vehicle is not in the overloaded state, the load determination unit 3B determines that the object which is loaded on the surrounding vehicle is not in the state where the object is protruding from the surrounding vehicle, the load determination unit 3B determines that the object which is loaded on the surrounding vehicle is not in the state where the object is not fixed to the surrounding vehicle.

In the example of the host vehicle 1 to which the surrounding situation recognition device 15 of the third embodiment is applied, even when it corresponds to the fourth case described above, in view of the fact that the object which is loaded on the surrounding vehicle may fall depending on the behavior of the surrounding vehicle, when the object which is loaded on the surrounding vehicle may fall, the warning indicating that it is necessary to make the distance between the surrounding vehicle and the host vehicle 1 greater than or equal to the predetermined value is output.

### Fourth Embodiment

The host vehicle 1 to which the surrounding situation recognition device 15 of a fourth embodiment is applied is configured in the same manner as the host vehicle 1 to which the surrounding situation recognition device 15 of the first embodiment described above is applied, except that it will be described later.

In the example shown in FIG. 1 (example of the host vehicle 1 to which the surrounding situation recognition device 15 of the first embodiment is applied), as described above, the load determination unit 3B determines whether the surrounding vehicle is loading the object based on the measurement result of the surrounding situation sensor 11 by using the model obtained by performing learning using teacher data which is the data set of, for example, the measurement result of the surrounding situation sensor mounted on the learning vehicle and the label indicating whether the surrounding vehicle (learning surrounding vehicle) which is located in the vicinity of the learning vehicle and which is the measurement target of the surrounding situation sensor mounted on the learning vehicle is loading the object (learning object).

On the other hand, in an example of the host vehicle 1 to which the surrounding situation recognition device 15 of the fourth embodiment is applied, the load determination unit 3B determines whether the surrounding vehicle exists in the image as the measurement result of the surrounding situation sensor 11. The load determination unit 3B determines whether the surrounding vehicle exists in the image based on the image as the measurement result of the surrounding situation sensor 11, for example, by using a model obtained by performing learning using teacher data which is a data set of an image (learning image) as the measurement result of the surrounding situation sensor mounted on the learning vehicle and a label indicating whether the surrounding vehicle (learning surrounding vehicle) exists in the image.

The load determination unit 3B determines whether the object which is different from the surrounding vehicle exists on a vehicle area of the surrounding vehicle in the image as the measurement result of the surrounding situation sensor 11. The load determination unit 3B determines whether the object which is different from the surrounding vehicle exists on the vehicle area of the surrounding vehicle in the image based on the image as the measurement result of the surrounding situation sensor 11, for example, by using a model obtained by performing learning using teacher data which is a data set of an image (learning image) as the measurement result of the surrounding situation sensor mounted on the learning vehicle and a label indicating whether the object (learning object) which is different from the surrounding vehicle (learning surrounding vehicle) exists on the vehicle area of the surrounding vehicle (learning surrounding vehicle) in the image.

Furthermore, the load determination unit 3B determines whether the relative positional relationship between the surrounding vehicle and the object (object which is different from the surrounding vehicle) in the image as the measurement result of the surrounding situation sensor 11 is constant. The load determination unit 3B determines whether the relative positional relationship between the surrounding vehicle and the object (object which is different from the learning vehicle) in the image as the measurement result of the surrounding situation sensor 11 is constant based on the image as the measurement result of the surrounding situation sensor 11, for example, by using a model obtained by performing learning using teacher data which is a data set of an image (learning image) as the measurement result of the surrounding situation sensor mounted on the learning vehicle and a label indicating whether the relative positional relationship between the surrounding vehicle (learning surrounding vehicle) and the learning object (object which is different from the learning surrounding vehicle) in the image is constant.

Further, the load determination unit 3B determines that the surrounding vehicle is loading the object when the surrounding vehicle exists in the image as the measurement result of the surrounding situation sensor 11 and the object which is different from the surrounding vehicle exists on the vehicle area of the surrounding vehicle in the image and when the relative positional relationship between the surrounding vehicle and the object is constant.

### Fifth Embodiment

The host vehicle 1 to which the surrounding situation recognition device 15 of a fifth embodiment is applied is configured in the same manner as the host vehicle 1 to which the surrounding situation recognition device 15 of the first embodiment described above is applied, except that it will be described later.

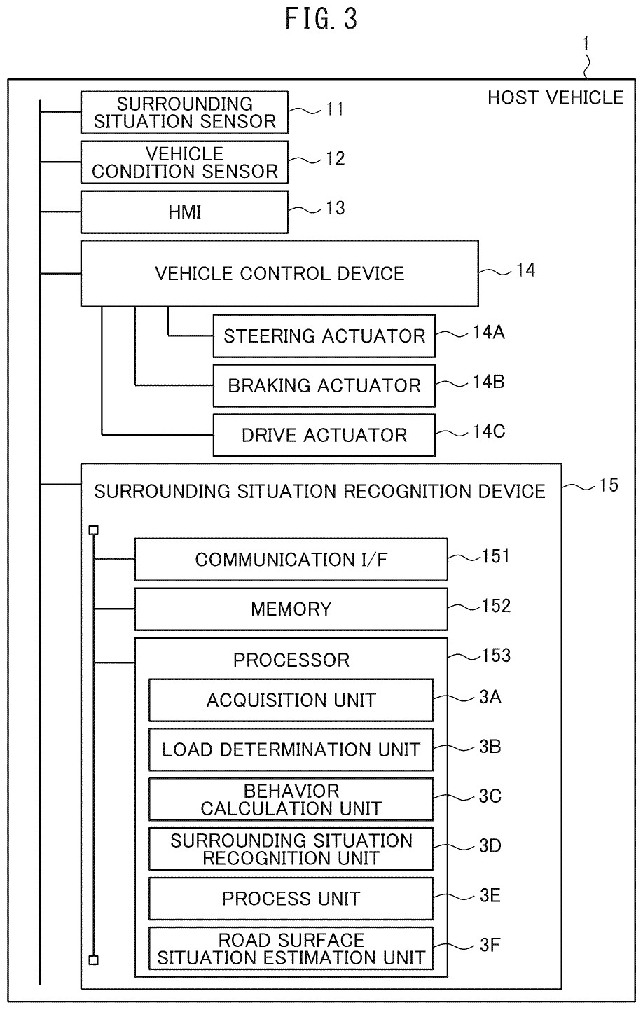

FIG. 3 is a view showing an example of the host vehicle 1 to which the surrounding situation recognition device 15 of the fifth embodiment is applied.

In the example shown in FIG. 3, the processor 153 has the function as the acquisition unit 3A, the function as the load determination unit 3B, the function as the behavior calculation unit 3C, the function as the surrounding situation recognition unit 3D, the function as the process unit 3E, and the function as a road surface situation estimation unit 3F.

The road surface situation estimation unit 3F estimates road surface situation of the road on which the surrounding vehicle and the host vehicle 1 are traveling based on the measurement result of the surrounding situation sensor 11 acquired by the acquisition unit 3A, and outputs the estimation result of, for example, bad road surface situation (for example, unpaved, rough road surface situation due to deterioration over time, disaster or the like), good road surface situation, etc.

The surrounding situation recognition unit 3D determines whether it is necessary to make the distance between the surrounding vehicle and the host vehicle 1 greater than or equal to the predetermined value based on the parameter representing the behavior of the surrounding vehicle calculated by the behavior calculation unit 3C and the road surface situation estimated by the road surface situation estimation unit 3F, when it is determined that the surrounding vehicle is loading the object by the load determination unit 3B.

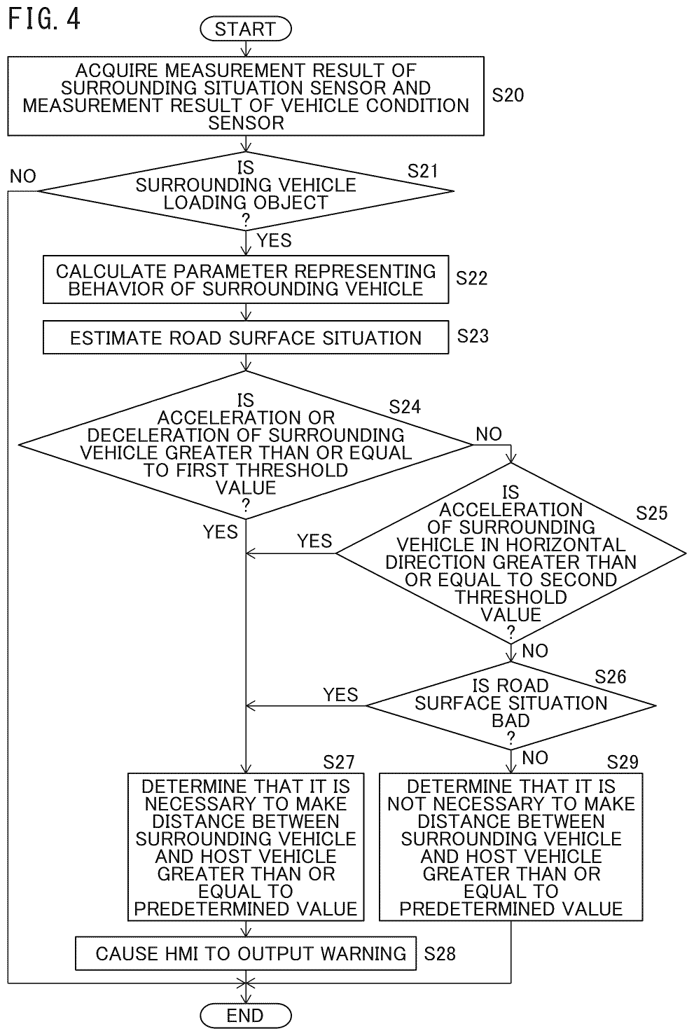

FIG. 4 is a flowchart for explaining an example of the process performed by the processor 153 of the surrounding situation recognition device 15 of the fifth embodiment.

In the example shown in FIG. 4, at step S20, the acquisition unit 3A acquires the measurement result of the surrounding situation sensor 11 from the surrounding situation sensor 11. The acquisition unit 3A acquires the measurement result of the vehicle condition sensor 12 from the vehicle condition sensor 12.

At step S21, the load determination unit 3B determines whether the surrounding vehicle is loading the object based on the measurement result of the surrounding situation sensor 11 acquired at step S20. When YES, it proceeds to step S22; when NO, the process shown in FIG. 4 ends.

At step S22, the behavior calculation unit 3C calculates the parameter (acceleration or deceleration of the surrounding vehicle in the front-back direction with respect to the road surface, acceleration of the surrounding vehicle in the horizontal direction in the image which shows the measurement result of the surrounding situation sensor 11) representing the behavior of the surrounding vehicle based on the measurement result of the surrounding situation sensor 11 and the measurement result of the vehicle condition sensor 12 acquired at step S20.

At step S23, the road surface situation estimation unit 3F estimates the road surface situation of the road on which the surrounding vehicle and the host vehicle 1 are traveling based on the measurement result of the surrounding situation sensor 11 acquired at step S20.

At step S24, the surrounding situation recognition unit 3D determines whether the acceleration or the deceleration of the surrounding vehicle in the front-back direction with respect to the road surface calculated at step S22 is greater than or equal to the first threshold value. When YES, it proceeds to step S27; when NO, it proceeds to step S25.

At step S25, the surrounding situation recognition unit 3D determines whether the acceleration of the surrounding vehicle in the horizontal direction in the image which shows the measurement result of the surrounding situation sensor 11 calculated at step S22 is greater than or equal to the second threshold value. When YES, it proceeds to step S27; when NO, it proceeds to step S26.

At step S26, the surrounding situation recognition unit 3D determines whether the road surface situation of the road on which the surrounding vehicle and the host vehicle 1 are traveling is bad based on the estimation result at step S23. When YES, it proceeds to step S27; when NO, it proceeds to step S29.

At step S27, the surrounding situation recognition unit 3D determines that it is necessary to make the distance between the surrounding vehicle and the host vehicle 1 greater than or equal to the predetermined value. In other words, the surrounding situation recognition unit 3D determines that the object which is loaded on the surrounding vehicle may fall from the surrounding vehicle.

At step S28, the process unit 3E performs the process for causing the HMI 13 to output the warning indicating that it is necessary to make the distance between the surrounding vehicle and the host vehicle greater than or equal to the predetermined value.

At step S29, the surrounding situation recognition unit 3D determines that it is not necessary to make the distance between the surrounding vehicle and the host vehicle 1 greater than or equal to the predetermined value. In other words, the surrounding situation recognition unit 3D determines that there is no possibility that the object which is loaded on the surrounding vehicle falls from the surrounding vehicle.

As described above, although the embodiments of the surrounding situation recognition device, the surrounding situation recognition method, and the non-transitory recording medium of the present disclosure have been described with reference to the drawings, the surrounding situation recognition device, the surrounding situation recognition method, and the non-transitory recording medium of the present disclosure are not limited to the embodiments described above, and may be appropriately changed without departing from the scope of the present disclosure. The configuration of each example of the embodiment described above may be appropriately combined. In each example of the above-described embodiment, the process performed in the surrounding situation recognition device 15 has been described as software process performed by executing the program, but the process performed in the surrounding situation recognition device 15 may be process performed by hardware. Alternatively, the process performed by the surrounding situation recognition device 15 may be a combination of both software and hardware. Further, the program (program for realizing the function of the processor 153 of the surrounding situation recognition device 15) stored in the memory 152 of the surrounding situation recognition device 15 may be recorded in a computer-readable storage medium (non-transitory recording medium) such as, semiconductor memory, magnetic recording medium, optical recording medium, or the like for providing, distribution or the like.

1. A surrounding situation recognition device comprising a processor configured to:
determine whether a surrounding vehicle located in a vicinity of a host vehicle is loading an object;
calculate a parameter representing behavior of the surrounding vehicle; and
determine whether it is necessary to make a distance between the surrounding vehicle and the host vehicle greater than or equal to a predetermined value based on the parameter representing the behavior of the surrounding vehicle when it is determined that the surrounding vehicle is loading the object.

2. The surrounding situation recognition device according to claim 1, wherein acceleration and deceleration of the surrounding vehicle and acceleration of the surrounding vehicle in a horizontal direction in an image which shows measurement result of a surrounding situation sensor mounted on the host vehicle are included in the parameter representing the behavior of the surrounding vehicle, and the processor is configured to:
determine that it is necessary to make the distance between the surrounding vehicle and the host vehicle greater than or equal to the predetermined value when it is determined that the surrounding vehicle is loading the object and when the acceleration or the deceleration of the surrounding vehicle is greater than or equal to a first threshold value; and
determine that it is necessary to make the distance between the surrounding vehicle and the host vehicle greater than or equal to the predetermined value when it is determined that the surrounding vehicle is loading the object and when the acceleration of the surrounding vehicle in the horizontal direction is greater than or equal to a second threshold value.

3. The surrounding situation recognition device according to claim 1, wherein the processor is configured to:
estimate road surface situation of a road on which the surrounding vehicle and the host vehicle are traveling; and
determine that it is necessary to make the distance between the surrounding vehicle and the host vehicle greater than or equal to the predetermined value based on the parameter representing the behavior of the surrounding vehicle and the road surface situation when it is determined that the surrounding vehicle is loading the object.

4. A surrounding situation recognition method comprising:
determining whether a surrounding vehicle located in a vicinity of a host vehicle is loading an object;
calculating a parameter representing behavior of the surrounding vehicle; and
determining whether it is necessary to make a distance between the surrounding vehicle and the host vehicle greater than or equal to a predetermined value based on the parameter representing the behavior of the surrounding vehicle when it is determined that the surrounding vehicle is loading the object.

5. A non-transitory recording medium having recorded thereon a computer program for causing a processor to perform a process comprising:
determining whether a surrounding vehicle located in a vicinity of a host vehicle is loading an object;
calculating a parameter representing behavior of the surrounding vehicle; and
determining whether it is necessary to make a distance between the surrounding vehicle and the host vehicle greater than or equal to a predetermined value based on the parameter representing the behavior of the surrounding vehicle when it is determined that the surrounding vehicle is loading the object.
